(19) United States
(12) Patent Application Publication
(10) Pub. No.: US 2025/0371384 A1
(43) Pub. Date: Dec. 4, 2025

(54) SWAPPING MODELS BASED ON INFERENCE REQUEST MONITORING

(71) Applicant: Snowflake Inc., Bozeman, MT (US)

(72) Inventors: Vincent Chan, Bellevue, WA (US); Xu Chen, Los Altos, CA (US); Pawel Pollak, Warszawa (PL); Zhaotian Wang, Newark, CA (US); Hao Zhang, San Diego, CA (US)

(21) Appl. No.: 18/679,855

(22) Filed: May 31, 2024

(51) Int. Cl. G06N 5/04

(52) U.S. Cl. CPC G06N 5/04

(57) ABSTRACT

Various embodiments described herein provide for systems, methods, devices, instructions, and like for swapping artificial intelligence models, such as large language models (LLMs), based on inference request monitoring. In particular, some embodiments monitor inference requests submitted to various inference engines (where each inference engine comprises a group of software containers sharing assigned computing resources) and, based on analysis of inference request data, available models, currently loaded models, or a combination thereof, determine whether to swap out a set of AI models currently active on a select inference engine with another set of AI models available on the select inference engine.

### TECHNICAL FIELD

Embodiments described herein relate to data systems and, more particularly, to systems, methods, devices, and instructions for swapping artificial intelligence models, such as large language models and other generative models, based on inference request monitoring.

### BACKGROUND

Artificial intelligence (AI) models, such as large language models (LLMs), have become integral to a variety of applications, ranging from natural language processing tasks such as translation and summarization to more interactive uses like conversational agents and automated content generation. The deployment and operation of these models, due to their size and complexity, require substantial computational resources, particularly graphics processing units (GPUs).

### BRIEF DESCRIPTION OF THE SEVERAL VIEWS OF THE DRAWINGS

Various ones of the appended drawings merely illustrate various embodiments of the present disclosure and should not be considered as limiting its scope. In the drawings, which are not necessarily drawn to scale, like numerals may describe similar components in different views. To easily identify the discussion of any particular element or act, the most significant digit or digits in a reference number refer to the figure number in which that element is first introduced.

FIG. 1 illustrates an example computing environment comprising a database system in the example form of a network-based database system that includes an artificial intelligence platform, according to some embodiments of the present disclosure.

FIG. 2 is a block diagram illustrating components of a compute service manager, according to some embodiments of the present disclosure.

FIG. 3 is a block diagram illustrating components of an execution platform, according to some embodiments of the present disclosure.

FIG. 4 is a flowchart of an example method for swapping AI models based on inference request monitoring, according to some embodiments of the present disclosure.

FIG. 5 is a block diagram illustrating a system that represents an example implementation of an artificial intelligence platform with dynamic model swapping, according to some embodiments of the present disclosure.

FIG. 6 illustrates a diagrammatic representation of a machine in the form of a computer system within which a set of instructions can be executed for causing the machine to perform any one or more of the methodologies discussed herein, according to some embodiments of the present disclosure.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In typical deployments, AI models (e.g., LLMs and other machine learning (ML) models) are hosted on cloud-based infrastructures that utilize containerization technologies, such as KUBERNETES. A software container can comprise an executable unit or package of software that comprises components needed to run a given software application, where the components can include the code for the given software application, a runtime environment in which the software application will execute, and libraries and dependencies used by the given software application during execution. Containers are generally designed to run consistently across different computing environments, providing a standardized unit of software deployment. KUBERNETES and the like can orchestrate multiple containers across a cluster of machines and can manage tasks such as deployment, scaling, and load balancing. In KUBERNETES and similar container technologies, a container grouping (or container orchestration pod) can comprise a group of one or more containers that share certain computing resources (e.g., data storage, networking, central processor unit (CPU) resources, graphical processor unit (GPU) resources, and the like) and a specification on how to run the containers. A container grouping (or pod) can represent the smallest deployable and manageable unit, and each container grouping (or pod) can be configured to run a single instance of a given software application.

Generally, it is a challenge to ensure efficient use of computing resources in container environments that host AI models, especially GPU resources (e.g., physical GPU cores). While originally intended to be highly specialized hardware accelerators for rendering graphics, today's GPUs have evolved into a key component for operating ML models such as LLMs. GPUs are not only expensive to purchase, but also very power-intensive when they are operating (e.g., facilitating an operation of an LLM). Accordingly, ensuring that GPUs and other computing resources are not underutilized or wasted is crucial for cost efficiency and environmental considerations.

Typically, each individual AI model (e.g., each LLM) is statically assigned to a specific set of computing resources (e.g., GPU resources) for the duration of the AI model's deployment, and this static assignment can lead to resource-use inefficiencies. For instance, some AI models may experience high demand and fully use their assigned set of GPU resources, while the set of GPU resources assigned to other AI models may idle due to lower demand. Such an imbalance can lead to situations where the available computing resources (e.g., GPU computational power) is not aligned with the actual computing resource needs. Additionally, the process of reallocating computing resources to different AI models is not trivial. It can involve manual intervention and result in downtime during redeployment. This is particularly problematic in environments where high availability and low latency is expected. Management of these computing resources with respect to containers is further complicated by the need to handle failures and updates gracefully. While KUBERNETES and other container technologies provide mechanisms for rolling updates and for restarting failed container groups (e.g., pods), but these mechanisms can still lead to temporary reductions in available computational capacity.

Various embodiments described herein provide for systems, methods, devices, instructions, and like for swapping AI models, such as large language models (LLMs), based on inference request monitoring. Some embodiments enable the deployment and management of multiple AI models within a containerized computing environment (e.g., KUBERNETES pods or other container orchestration pods), while balancing the need for computing resources with the cost and complexity of managing those computing resources efficiently. In particular, use of various embodiments can enhance the efficiency and cost-effectiveness of resource utilization, especially with respect to optimal use of graphics processing units (GPUs).

According to some embodiments, a system comprises a dynamic model swapper configured to monitor inference requests submitted to various inference engines, where each inference engine comprises a group of software containers sharing assigned computing resources (e.g., computing resources designated to and reserved for use by the group of software containers). The assigned computing resources can include one or more GPUs or CPUs, which can be used to execute a loaded AI model on the inference engine to service one or more inference requests (e.g., received from clients). The dynamic model swapper can keep track of both AI models available on individual inference engines for loading, and AI models currently loaded (e.g., active) on the individual inference engines. Based on analysis of inference request data, available models, currently loaded models, or a combination thereof, the dynamic model swapper can determine whether to swap out a set of AI models currently active on a select inference engine with another set of AI models available on the select inference engine. The swapping can be performed in real-time (or in near real-time) and can comprise unloading the set of AI models currently active on the select inference engine and loading the other set of AI models available on the select inference engine. For example, when a swap decision is made, the dynamic model swapper can cause a first set of AI models (e.g., of a first type of AI model) to be unloaded from (e.g., unloaded from the memory of) one or more GPUs to primary memory, and cause a second set of AI models (e.g., of a second type of AI model) to be loaded to the one or more GPUs (e.g., loaded from the primary memory), where the one or more GPUs and the primary memory are those assigned to (e.g., designated to and reserved for use by) the select inference engine. Depending on the embodiment, the loading of an AI model to a select GPU can comprise loading the AI model to memory of the select GPU, thereby rendering the AI model active on the select GPU. Likewise, the unloading of an AI model from a select GPU can comprise unloading the AI model from memory of the select GPU, thereby rendering the AI model inactive. Additionally, an individual inference engine can be configured to load and use a single type of AI model (to service inference requests) at a given time. For various embodiments, loading and unloading of AI models within an individual inference engine is performed without need for the individual inference engine (e.g., a group of software containers implementing the individual inference engine) to restart itself. Overall, the swapping of Al models in and out (e.g., of active GPU memory) for use within individual inference engines can be performed such that the transition between active Al models within an individual inference engine is seamless. The decision to swap can be driven, for example, by the need to optimize response times and resource utilization according to the changing demand for different AI model types (e.g., change in demand being determined by the inference request data). By dynamically loading and unloading AI models to and from inference engines in this manner, a system of various embodiments can manage and ensure efficient use of computing resources (assigned to inference engines).

For some embodiments, the system is configured such that an external client device views (e.g., perceives) that a particular type of AI model (e.g., GPT-4, Mistral Large, Llama-2, Claude-2, etc.) is available for servicing an inference request from the external client device (regardless of whether the particular type of AI model is currently loaded on any the system's inference engines) as long as at least one of the system's inference engines has the particular type of AI model available for loading (e.g., via swapping). The dynamic swapping and seamless transition of AI models within individual inference engines of a system enable the system to indicate availability in such a manner regardless of current load status.

For some embodiments, the system comprises a request receiver (e.g., a plurality of request receivers) configured to receive and manage inference requests received from one or more clients. Each inference request can comprise model input data (e.g., prompt input for an LLM), and can indicate an AI model to be used to service the inference request by generating model output data based on the model input data. For example, where the model input data is a prompt input, the indicated AI model can perform an inference operation using the prompt input and generate a prompt output, which can comprise text, audio, image, or video content. Management of inference requests can include forwarding individual inference requests to select inference engines based on one or more of: content of the inference requests (e.g., indicated AI model type, size of the inference request, priority of the inference request, etc.); current request load of a given inference engine (e.g., in comparison to other inference engine); active set of AI models on a given inference engine (e.g., type of AI models active on the given inference engine); set of AI models available on the given inference engine; and current performance of a given inference engine. The request receiver can categorize or quantify inference request workload (or load) per a different AI model type and provide the dynamic model swapper with this information, or the request receiver can (e.g., upon request) provide data that permits the dynamic model swapper to categorize or quantify the inference request load locally on the dynamic model swapper. For some embodiments, inference request load per a different AI model type is determined based on one or more metrics, such as a count (e.g., aggregated count) of words or tokens received in the inference requests.

For various embodiments, the system (e.g., the dynamic model swapper) monitors the distribution of AI model types across a plurality of inference engines and, determines (e.g., evaluates) whether the number of inference engines loaded (e.g., active) with a particular AI model type falls below a predefined threshold (e.g., predefined threshold for the particular AI model type). In response to determining that the number of inference engines loaded (e.g., active) with the particular AI model type has fallen below a predefined threshold, the system can cause one or more inference engines (in the plurality of inference engines) that have the particular AI model available but not loaded to load a set of AI models of the particular AI model type (e.g., by swapping their respective active set of AI models with the set of AI models of the particular AI model type). The determination of whether the number of inference engines loaded with a particular AI model type has fallen below a predefined threshold can periodically occur for a given inference engine, or can occur after a certain event (e.g., after a model swap has occurred on the given inference engine or any inference engine of the plurality of inference engines).

By dynamically swapping models based on real-time demand, a system of an embodiment can ensure that inference engines in groups of software containers optimally use computational resources, reduce idle times, and reduce energy consumption. A system of an embodiment can scale its operations up or down based on the intensity and type of inference requests, thereby providing flexibility and robustness in handling varying inference request workloads. A system of an embodiment can quickly adapt to changing inference request demands to ensure that the system offers timely and accurate inference request responses, thereby enhancing overall user satisfaction. Additionally, a system of an embodiment can handle different operational scenarios, including peak loads and node failures, thereby enhancing the efficiency and responsiveness of services that rely on the inference engines described herein.

As used herein, an artificial intelligence model (or AI model) can comprise a generative model or another type of machine learning model. A generative model can refer to any type of AI model that can create new content from training data. For example, a generative model can generate text, images, video, audio, code, or synthetic data similar to the original data (e.g., input data) but not identical. A large-language model (LLM) can represent one type of generative model. An LLM can include, without limitation, a GPT model (e.g., GPT-4), a Llama model (e.g., Llama-2), or another type of generative model (e.g., a proprietary or tailored model). Generally, an LLM comprises one or more transformer neural networks, which can be configured (e.g., trained) for general-purpose language generation or another natural language processing task.

Reference will now be made in detail to various embodiments of the present disclosure, examples of which are illustrated in the appended drawings. The present disclosure may, however, be embodied in many different forms and should not be construed as being limited to the examples set forth herein.

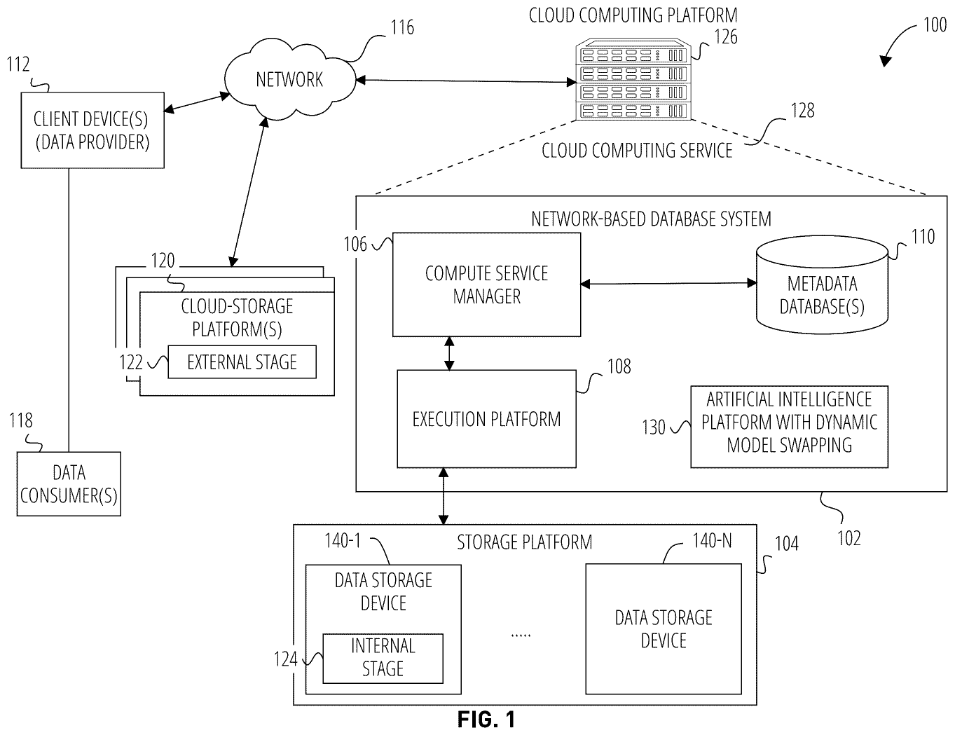

FIG. 1 illustrates an example computing environment 100 comprising a database system in the example form of a network-based database system 102 that includes an artificial intelligence platform 130, according to some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some embodiments, the computing environment 100 may include a cloud computing platform 126 with the network-based database system 102, and a storage platform 104 (also referred to as a cloud storage platform). The cloud computing platform 126 provides computing resources and storage resources that may be acquired (purchased) or leased and configured to execute applications and store data.

The cloud computing platform 126 may host a cloud computing service 128 that facilitates storage of data on the cloud computing platform 126 (e.g., data management and access) and analysis functions (e.g., SQL queries, analysis), as well as other processing capabilities (e.g., configuring replication group objects as described herein). The cloud computing platform 126 may include a three-tier architecture: data storage (e.g., storage platforms 104), an execution platform 108 (e.g., providing query processing), and a compute service manager 106 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM®, and/or the like. The customer's servers and cloud-storage platforms are both examples of what a given customer could use as what is referred to herein as an external storage location. The cloud computing platform 126 could also use a cloud-storage platform as what is referred to herein as an internal storage location concerning the data platform.

From the perspective of the network-based database system 102 of the cloud computing platform 126, one or more files that are stored at one or more storage locations are referred to herein as being organized into one or more of what is referred to herein as either “internal stages” or “external stages.” Internal stages (e.g., internal stage 124) are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 126 is in communication with the storage platforms 104 and cloud-storage platforms 120 (e.g., AWS®, Microsoft Azure Blob Storage®, or Google Cloud Storage). The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 106, an execution platform 108, and one or more metadata databases 110. The network-based database system 102 hosts and provides data reporting and analysis services to multiple client accounts.

The compute service manager 106 coordinates and manages operations of the network-based database system 102. The compute service manager 106 also performs query optimization and compilation as well as managing clusters of computing services that provide compute resources (also referred to as “virtual warehouses”). The compute service manager 106 can support any number of client accounts such as end-users providing data storage and retrieval requests, system administrators managing the systems and methods described herein, and other components/devices that interact with compute service manager 106.

The compute service manager 106 is also in communication with a client device 112. The client device 112 corresponds to a user of one of the multiple client accounts supported by the network-based database system 102. A user may utilize the client device 112 to submit data storage, retrieval, and analysis requests to the compute service manager 106. Client device 112 (also referred to as remote computing device or user client device 112) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 126 (e.g., cloud computing service 128) by way of a network 116, such as the Internet or a private network. A data consumer 118 can use another computing device to access the data of the data provider (e.g., data obtained via the client device 112).

In the description below, actions are ascribed to users, particularly consumers and providers. Such actions shall be understood to be performed concerning client device (or devices) 112 operated by such users. For example, a notification to a user may be understood to be a notification transmitted to the client device 112, input or instruction from a user may be understood to be received by way of the client device 112, and interaction with an interface by a user shall be understood to be interaction with the interface on the client device 112. In addition, database operations (joining, aggregating, analysis, etc.) ascribed to a user (consumer or provider) shall be understood to include performing such actions by the cloud computing service 128 in response to an instruction from that user.

The compute service manager 106 is also coupled to one or more metadata databases 110 that store metadata about various functions and aspects associated with the network-based database system 102 and its users. For example, a metadata database 110 may include a summary of data stored in remote data storage systems as well as data available from a local cache. Additionally, a metadata database 110 may include information regarding how data is organized in remote data storage systems (e.g., the cloud storage platform 104) and the local caches. Information stored by a metadata database 110 allows systems and services to determine whether a piece of data needs to be accessed without loading or accessing the actual data from a storage device. In some embodiments, metadata database 110 is configured to store account object metadata (e.g., account objects used in connection with a replication group object).

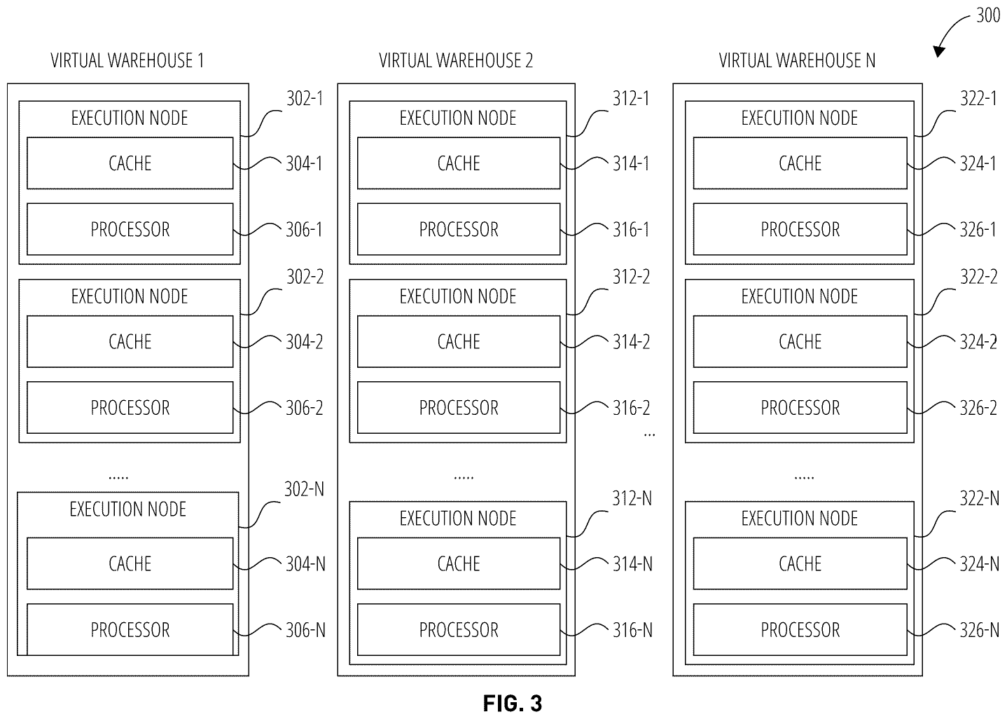

The compute service manager 106 is further coupled to the execution platform 108, which provides multiple computing resources that execute various data storage and data retrieval tasks. As illustrated in FIG. 3, the execution platform 108 comprises a plurality of compute nodes. The execution platform 108 is coupled to storage platform 104 and cloud-storage platforms 120. The storage platform 104 comprises multiple data storage devices 140-1 to 140-N. In some embodiments, the data storage devices 140-1 to 140-N are cloud-based storage devices located in one or more geographic locations. For example, the data storage devices 140-1 to 140-N may be part of a public cloud infrastructure or a private cloud infrastructure. The data storage devices 140-1 to 140-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 124 may reside on one or more of the data storage devices 140-1-140-N, and at least one external stage 122 may reside on one or more of the cloud-storage platforms 120.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternative embodiments, these communication links are implemented using any type of communication medium and any communication protocol.

The compute service manager 106, metadata database(s) 110, execution platform 108, and storage platform 104, are shown in FIG. 1 as individual discrete components. However, each of the compute service manager 106, metadata database(s) 110, execution platform 108, and storage platform 104 may be implemented as a distributed system (e.g., distributed across multiple systems/platforms at multiple geographic locations). Additionally, each of the compute service manager 106, metadata database(s) 110, execution platform 108, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 106. These jobs are scheduled and managed by the compute service manager 106 to determine when and how to execute the job. For example, the compute service manager 106 may divide the job into multiple discrete tasks and may determine what data is needed to execute each of the multiple discrete tasks. The compute service manager 106 may assign each of the multiple discrete tasks to one or more nodes of the execution platform 108 to process the task. The compute service manager 106 may determine what data is needed to process a task and further determine which nodes within the execution platform 108 are best suited to process the task. Some nodes may have already cached the data needed to process the task and, therefore, be a good candidate for processing the task. Metadata stored in a metadata database 110 assists the compute service manager 106 in determining which nodes in the execution platform 108 have already cached at least a portion of the data needed to process the task. One or more nodes in the execution platform 108 process the task using data cached by the nodes and, if necessary, data retrieved from the storage platform 104. It is desirable to retrieve as much data as possible from caches within the execution platform 108 because the retrieval speed is typically much faster than retrieving data from the storage platform 104.

As shown in FIG. 1, the cloud computing platform 126 of the computing environment 100 separates the execution platform 108 from the storage platform 104. In this arrangement, the processing resources and cache resources in the execution platform 108 operate independently of the data storage devices 140-1 to 140-N in the storage platform 104. Thus, the computing resources and cache resources are not restricted to specific data storage devices 140-1 to 140-N. Instead, all computing resources and all cache resources may retrieve data from, and store data to, any of the data storage resources in the storage platform 104.

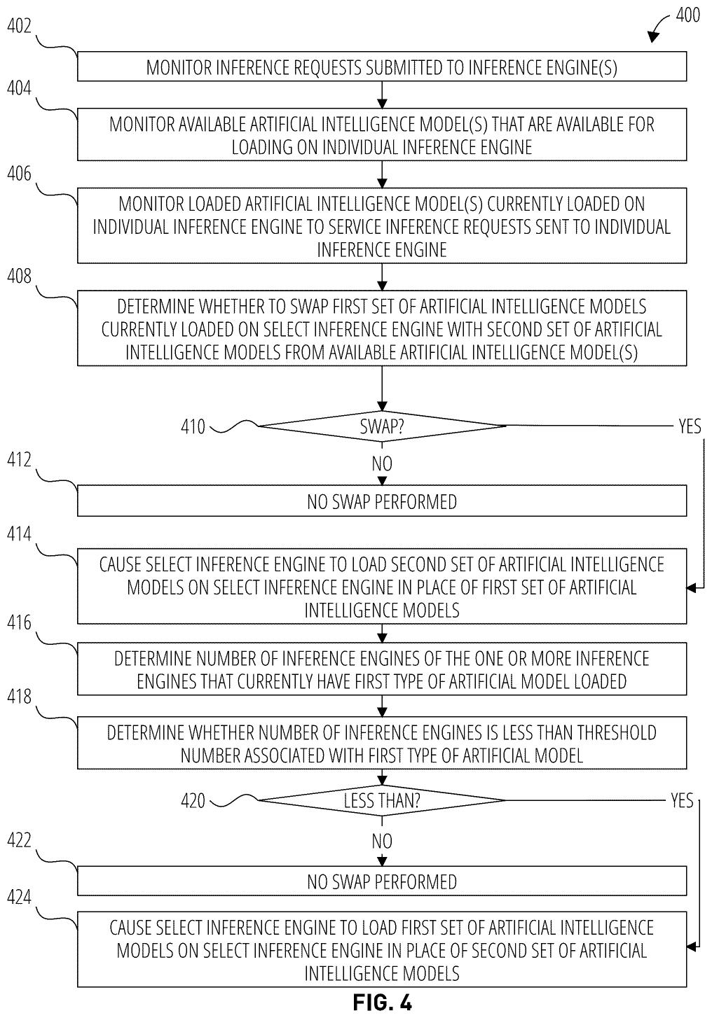

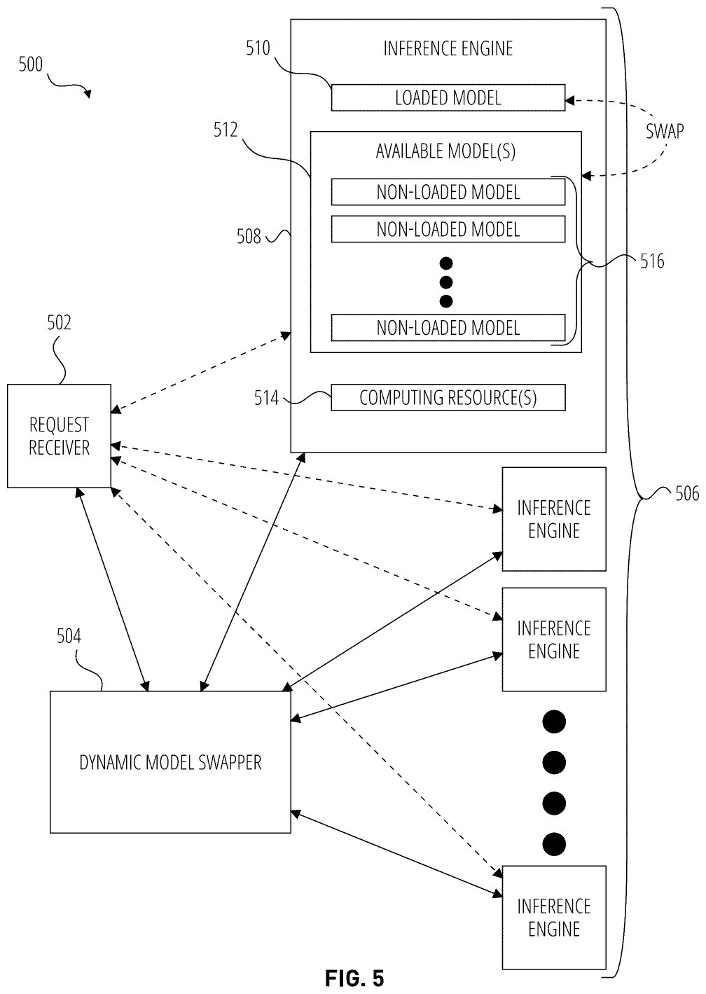

As also shown, the network-based database system 102 comprises the artificial intelligence platform with dynamic model swapping 130 (hereafter, artificial intelligence platform 130) that incorporates swapping of AI models based on inference request monitoring in accordance with various embodiments. For example, the artificial intelligence platform 130 can implement a methodology similar to method 400 of FIG. 4. Additionally, an example implementation of the artificial intelligence platform 130 is described herein with respect to FIG. 5.

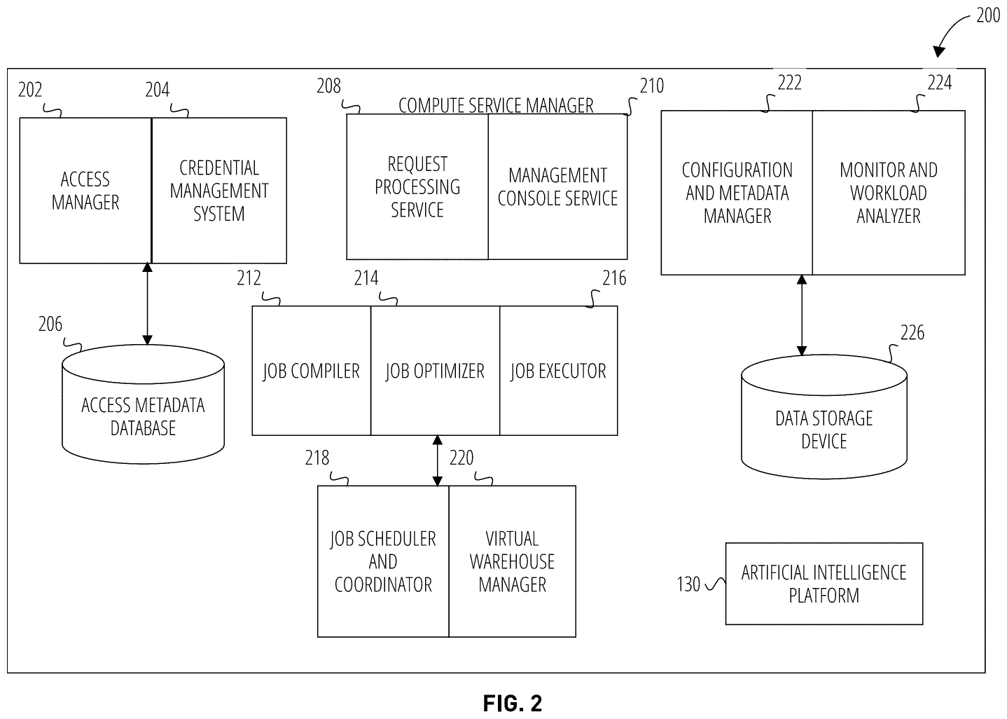

FIG. 2 is a block diagram 200 illustrating components of the compute service manager 106, according to some embodiments of the present disclosure. As shown in FIG. 2, the compute service manager 106 includes an access manager 202 and a credential management system 204 coupled to access metadata database 206, which is an example of the metadata database(s) 110.

Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service execution platform 108 may determine the data to process a received query (e.g., a data storage request or data retrieval request). The data can be stored in a cache within the execution platform 108 or in a data storage device in storage platform 104.

A management console service 210 supports access to various systems and processes by administrators and other system managers. Additionally, the management console service 210 may receive a request to execute a job and monitor the workload on the system.

The compute service manager 106 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 106.

A job scheduler and coordinator 218 sends received jobs to the appropriate services or systems for compilation, optimization, and dispatch to the execution platform 108. For example, jobs can be prioritized and then processed in that prioritized order. In an embodiment, the job scheduler and coordinator 218 determines a priority for internal jobs that are scheduled by the compute service manager 106 with other “outside” jobs such as user queries that can be scheduled by other systems in the database but may utilize the same processing resources in the execution platform 108. In some embodiments, the job scheduler and coordinator 218 identifies or assigns particular nodes in the execution platform 108 to process particular tasks. A virtual warehouse manager 220 manages the operation of multiple virtual warehouses implemented in the execution platform 108. For example, the virtual warehouse manager 220 may generate query plans for executing received queries.

Additionally, the compute service manager 106 includes a configuration and metadata manager 222, which manages the information related to the data stored in the remote data storage devices and in the local buffers (e.g., the buffers in execution platform 108). The configuration and metadata manager 222 uses metadata to determine which data files need to be accessed to retrieve data for processing a particular task or job. A monitor and workload analyzer 224 oversees processes performed by the compute service manager 106 and manages the distribution of tasks (e.g., workload) across the virtual warehouses and execution nodes in the execution platform 108. The monitor and workload analyzer 224 also redistributes tasks, as needed, based on changing workloads throughout the cloud computing platform 126 and may further redistribute tasks based on a user (e.g., “external”) query workload that may also be processed by the execution platform 108. The configuration and metadata manager 222 and the monitor and workload analyzer 224 are coupled to a data storage device 226. Data storage device 226 in FIG. 2 represents any data storage device within the storage platform 104. For example, data storage device 226 may represent buffers in execution platform 108, storage devices in cloud storage platform 104, or any other storage device.

As described in embodiments herein, the compute service manager 106 validates all communication from an execution platform (e.g., the execution platform 108) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1) may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

FIG. 3 is a block diagram 300 illustrating components of the execution platform 108, according to some embodiments of the present disclosure. As shown in FIG. 3, the execution platform 108 includes multiple virtual warehouses, including virtual warehouse 1, virtual warehouse 2, and virtual warehouse N. Each virtual warehouse includes multiple execution nodes that each include a data cache, a processor (e.g., CPU), a graphical processor unit (GPU), or a combination thereof. The virtual warehouses can execute multiple tasks in parallel by using the multiple execution nodes. As discussed herein, the execution platform 108 can add new virtual warehouses and drop existing virtual warehouses in real-time based on the current processing needs of the systems and users. This flexibility allows the execution platform 108 to quickly deploy large amounts of computing resources when needed without being forced to continue paying for those computing resources when they are no longer needed. All virtual warehouses can access data from any data storage device (e.g., any storage device in storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 140-1 to 140-N shown in FIG. 1. Thus, the virtual warehouses are not necessarily assigned to a specific data storage device 140-1 to 140-N and, instead, can access data from any of the data storage devices 140-1 to 140-N within the storage platform 104. Similarly, each of the execution nodes shown in FIG. 3 can access data from any of the data storage devices 140-1 to 140-N. In some embodiments, a particular virtual warehouse or a particular execution node can be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse N includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 108, the virtual warehouses can be implemented using multiple computing systems at multiple geographic locations. For example, virtual warehouse I can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse can be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 108 is also fault tolerant. For example, if one virtual warehouse fails, that virtual warehouse is quickly replaced with a different virtual warehouse at a different geographic location. A particular execution platform 108 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

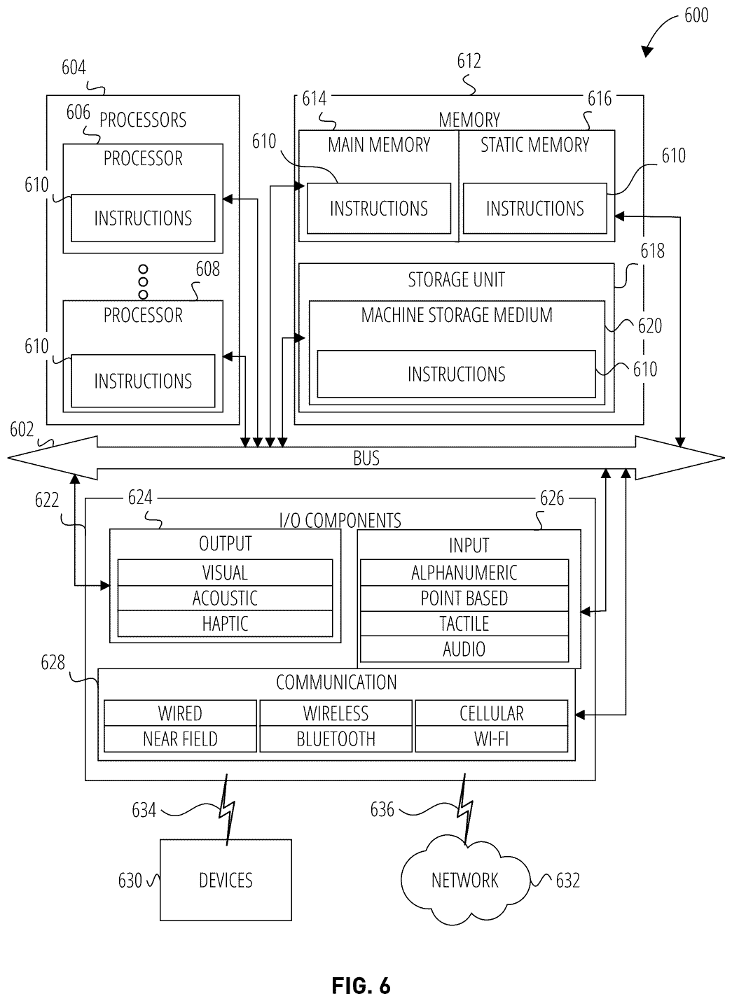

FIG. 4 is a flowchart of an example method 400 for swapping AI models based on inference request monitoring, according to some embodiments of the present disclosure. Method 400 may be embodied in computer-readable instructions for execution by one or more hardware components (e.g., one or more processors) such that the operations of method 400 can be performed by components of the artificial intelligence platform 130 or the network-based database system 102, such as a network node (e.g., the artificial intelligence platform 130 executing on a network node of the compute service manager 106) or a computing device (e.g., client device 112), one or both of which may be implemented as machine 600 of FIG. 6 performing the disclosed functions. Accordingly, method 400 is described below, by way of example with reference thereto. However, it shall be appreciated that method 400 may be deployed on various other hardware configurations and is not intended to be limited to deployment within the network-based database system 102.

At operation 402, a hardware processor (e.g., implementing the artificial intelligence platform 130) monitors inference requests submitted to one or more inference engines (e.g., plurality of inference engines, such as plurality of inference engines 506 of FIG. 5). For example, the dynamic model swapper 504 can monitor inference requests submitted to the request receiver 502 by one or more clients (e.g., client device 112) external to the system 500 of FIG. 5. For some embodiments, operation 402 is performed periodically (e.g., continuously), in response to an event or satisfaction of a condition, or some combination of both. For some embodiments, each inference engine (e.g., inference engine 508 of FIG. 5) comprises a group of software containers (e.g., a KUBERNETES pod or the like) that share an assigned set of computing resources, where the one or more inference engines comprises a select inference engine. The assigned set of computing resources can comprise, for example, at least one of one or more GPUs, one or more CPUs, and primary memory (e.g., random access memory (RAM)) associated with the one or more CPUs. For some embodiments, operation 402 comprises querying (e.g., periodically or continuously) the request receiver (e.g., the dynamic model swapper 504 querying the request receiver 502 of FIG. 5) for inference request information; and determining a request load per a different type of AI model based on the inference request information. The request load per a different type of AI model can, for example, comprise a number of prompts or inference requests received (e.g., by the request receiver 502 of FIG. 5) per a different type of AI model, a count (e.g., aggregated count) of words received (e.g., by the request receiver 502 of FIG. 5) in inference requests per a different type of AI model, or a count (e.g., aggregated count) of tokens received (e.g., by the request receiver 502 of FIG. 5) in inference requests per a different type of Al model.

Operations 404 and 406 can be performed with respect to each individual inference engine of the one or more inference engines. At operation 404, the hardware processor (e.g., implementing the artificial intelligence platform 130) monitors one or more (available) AI models that are available for loading on an individual inference engine. For example, the dynamic model swapper 504 can monitor one or more AI models that are available for loading on each individual inference engine of the plurality of inference engines 506 of FIG. 5. For some embodiments, operation 404 is performed periodically (e.g., continuously), in response to an event or satisfaction of a condition, or some combination of both. At least one AI model of the one or more AI models can comprise an LLM. According to some embodiments, operation 404 comprises querying (e.g., periodically or continuously) the individual inference engine (e.g., the dynamic model swapper 504 querying one of the plurality of inference engines 506 of FIG. 5) to determine the one or more available AI models that are available for loading on the individual inference engine.

During operation 406, the hardware processor (e.g., implementing the artificial intelligence platform 130) monitors one or more (loaded) AI models currently loaded on the individual inference engine to service inference requests sent to an individual inference engine. For example, the dynamic model swapper 504 can monitor one or more AI models currently loaded on each individual inference engine of the plurality of inference engines 506 of FIG. 5. For some embodiments, operation 406 is performed periodically (e.g., continuously), in response to an event or satisfaction of a condition, or some combination of both. Each individual inference engine can, for instance, return to the dynamic model swapper 504, its respective status, where the status can include one or more of the following: AI model currently loaded (e.g., in a GPU assigned to the individual inference engine) for servicing (e.g., running) an inference request; AI models available (e.g., in CPU cache assigned to the individual inference engine) that can be swapped with the currently loaded AI model; whether the individual inference engine is in the process of swapping; or a number of inference requests running on the individual inference engine (e.g., which can represent the current inference request workload on the individual inference engine). For some embodiments, the determination to swap is based on a request load/workload-based rule. For example, the determination to swap can be based on a set of (e.g., ordered set of) rules that comprises: (1) if there is a request for a given AI model, and that AI model is not loaded in any inference engine, the system will choose an inference engine to load the given AI model (via a swap); (2) for a given AI model, if the number of inference engine that load the Al model is below a configured threshold, the system will choose an inference engine to load the given AI model (via a swap); (3) for a given AI model, if the real time requests is larger than a threshold, the system will choose an inference engine to load the given AI model (via swap); and (4) rebalance all the inference engines to make sure every AI model is loaded in at least one inference engine. A system can traverse the set of rules in order, and the system can be configured to perform a swap as long as one rule in the set of rules is satisfied. Additionally, a system (e.g., the dynamic model swapper 504) can go through the set of rules periodically, such as every M seconds (e.g., such as every 1 second). According to some embodiments, operation 406 comprises querying (e.g., periodically or continuously) the individual inference engine (e.g., the dynamic model swapper 504 querying one of the plurality of inference engines 506 of FIG. 5) to determine the one or more loaded AI models currently loaded on the individual inference engine. For example, the dynamic model swapper 504 (of FIG. 5) can continuously query the request receiver 502 (of FIG. 5) (e.g., each KUBERNETES replica of the request receiver is queried, and the results across the replicas are aggregated).

At operation 408, the hardware processor (e.g., implementing the artificial intelligence platform 130) determines whether to swap a first set of Al models currently loaded on the select inference engine with a second set of AI models from the one or more available AI models, where the second set of AI models is not currently loaded on the select inference engine. For example, the request receiver 502 can perform this determination with respect to the inference engine 508. For some embodiments, operation 408 is performed periodically (e.g., continuously), in response to an event or satisfaction of a condition, or some combination of both. According to some embodiments, the determination of operation 408 is performed based on the monitoring of the inference requests (by operation 402), the monitoring of the one or more available AI models (by operation 404), the monitoring of the one or more loaded AI models (by operation 406), or some combination thereof. For instance, the monitoring (by operation 402) of the inference requests submitted to the one or more inference engines can comprise determining inference request loads for different types of AI models. Where each AI model in the first set of AI models is a first type of AI model and each AI model in the second set of AI models is a second type of AI model, the determination (at operation 406) of whether to swap the first set of AI models currently loaded on the select inference engine with the second set of AI models can comprise determining to swap the first set of AI models with the second set of AI models in response to the second type of AI model having a higher inference request load than the first type of AI model. According to various embodiments, a set of AI models is loaded on the select inference engine by loading the set of AI models on one or more GPUs (e.g., memory of those one or more GPUs) of the assigned set of computing resources. A set of AI models (e.g., one of the available AI models) is loaded on the select inference engine from a persistent data storage resource (e.g., disk or solid-state data storage) of the assigned set of computing resources, or from a primary memory operably coupled to one or more CPUs of the assigned set of computing resources (e.g., where the persistent data storage resource or the primary memory can be used to cache one or more available AI models when they are not loaded).

As another example, the determination of operation 408 is performed in accordance with one or more of the following algorithms. According to one algorithm, the hardware processor can determine the number of pending prompts for each AI model type and adjust the distribution of loaded AI models in a plurality of inference engines (e.g., 506 of FIG. 5) based on the total pending prompts for each type of AI model. According to another algorithm, the hardware processor determines to swap a loaded AI model of a first AI model type for an unloaded AI model of a second AI model type on an individual inference engine if two conditions are satisfied: (1) the inference request load (e.g., as determined by the dynamic model swapper 504 based on inference requests received by the request receiver 502) for the first AI model type is above a predetermined threshold value (e.g., which is automatically predetermined or admin user set); and (2) the inference request load (e.g., as determined by the dynamic model swapper 504 based on inference requests received by the request receiver 502) for the second AI model type is less (e.g., much less) than the inference request load for the first AI model type. Example implementations of this algorithm are provided below in Table 1.

TABLE 1
FIRST ALGORITHM
Define i as a unique model, p as the number of pending prompts for a given AI model type,
w as the weight for a given AI model type (w indicates slowness of an AI model type, larger
w means the given AI model type needs more computing resource
for a given workload), and r as the number of inference engines that have a model of the
given AI model type loaded. By calculating the following Equation 1, various embodiments
estimate the load per inference engine for a given AI model type.
$f ( i ) = \frac{{p}_{i} {w}_{i}}{{r}_{i}}$
Equation 1
Define t1 to be our swapping threshold value, which can be chosen (e.g., by a user or an
automatic process) based on how many prompts our inference engine can handle, and the
candidate AI model m1 of a first AI model type for swapping as Equation 2.
${m}_{1} = arg max ( \{ f ( i ) \vert f ( i ) > {t}_{1} , ∀ i \} )$
Equation 2
Then to find another candidate AI model m2 of a second AI model type, which is the candidate
for m1 to swap with, we find the AI model type with the load per inference engine using
Equation 3.
${m}_{2} = arg max ( \{ f ( i ) , ∀ i \} )$
Equation 3
Define b as a scalar value (e.g., difference value) for how big the difference from f (m1) needs
to be from f(m2) in order to swap, and let's define t as a threshold value for when models
should not perform swaps (e.g., set just high enough so that models are not swapping at max
capacity).
${m}_{2} = swap ( m 1 ) if f ( {m}_{1} ) > bf ( {m}_{2} ) and f ( {m}_{2} ) < {t}_{2}$
Equation 4
(1) No swap during low traffic - When the AI model m1 of the first AI model type with the
highest load per inference engine does not meet the threshold, f(m₁) < t₁, no swaps will be
performed. This keeps various embodiments from swapping when there is already sufficient
inference engines loaded with AI models to handle a current load demand, and prevents
unnecessary swaps.
(2) No swap during max capacity - When the AI model m2 of the second AI model type with
the lowest load per inference engine does not meet the threshold, f(m₂) < t₂, no swaps will be
performed. This keeps various embodiments from swapping when all inference engines are at
full capacity, which can mean all of the inference engines are being used. Swapping here would
be detrimental, as there is work for all the inference engines to do.
(3) No swap when low difference in loads between models - Assuming previous threshold
conditions are met to perform a swap, if f(m₁) < bf(m₂), where the scalar b represents how
much larger f(m₁) needs to be in order to swap, a swap is not performed since the difference
between the two loads per inference engine is not large enough.
When all 3 of the previous conditions are met (e.g., f(m₁) ≥ t₁ , f(m₂) ≥ t₂, f(m₁) < bf(m₂)),
only then is a swap performed.
Alternatively, various embodiments determine a swap is worth doing if there is an overall
increase in throughput. For example, an embodiment can use the unit of time to complete a
workload for a given AI model type as a swap condition
SECOND ALGORITHM
Alternatively, various embodiments determine a swap is worth doing if there is an overall
increase in throughput. For example, an embodiment can use the unit of time to complete a
workload for a given AI model type as a swap condition.
Define i as a unique model, p as the number of pending prompts for a given AI model type, w
as prompts per second for the given AI model type, and r as the number of inference engines
that have a model of the given AI model type loaded. By calculating the following Equation 5,
various embodiments estimate the time to complete a workload of a model of the given AI
model type.
$f ( i ) = \frac{{p}_{i} {w}_{i}}{{r}_{i}}$
Equation 5
Define t1 to be our swapping threshold value that is chosen by how many prompts the inference
engine can handle, and define index j for the candidate AI model (of a first type of AI model)
for swapping by Equation 6.
$j = arg max ( \{ f ( i ) \vert f ( i ) > {t}_{1} , ∀ i \} )$
Equation 6
Equation 7 is used to find index k for the candidate AI model (of a second type of AI model),
with the least inference engine load, to swap with.
$k = arg max ( \{ f ( i ) \vert f ( i ) > {t}_{2} , ∀ i \} )$
Equation 7
Given s as the time in seconds it takes for a model to swap, various embodiments formulate the
time to complete the workloads for the swapped scenario and non-swapped scenario, where the
time to complete the workload for the swapped scenario must be less than the time to complete
the non-swapped scenario for the swap to occur. This is reflected by Equation 8.
$\frac{{p}_{j} + ( {sw}_{k} )}{{w}_{j} ( {r}_{j} + 1 )} + \frac{{p}_{k}}{{w}_{k} ( {r}_{k} - 1 )} < \frac{{p}_{j}}{{w}_{j} {r}_{j}} + \frac{{p}_{k}}{{w}_{k} ( {r}_{k} )}$
Equation 8

At decision block 410, if the hardware processor determines to swap the first set of AI models on the select inference engine with the second set of AI models, the method 400 proceeds to operation 414, otherwise the method 400 proceeds to operation 412 (where no swap is performed).

At operation 414, the hardware processor (e.g., implementing the artificial intelligence platform 130) causes the select inference engine to load the second set of AI models on the select inference engine in place of the first set of AI models. For some embodiments, operation 414 comprises unloading the first set of AI models from the select inference engine and, after the unloading of the first set of AI models, loading the second set of AI models on the select inference engine. The unloading of the first set of AI models from the select inference engine can comprise unloading the first set of AI models from one or more GPUs of the assigned set of computing resources to a primary memory operably coupled to one or more CPUs of the assigned set of computing resources. The loading of the second set of AI models on the select inference engine can comprise loading the second set of AI models from the primary memory to the one or more GPUs. For some embodiments, operation 414 comprises sending a request (e.g., via an application programming interface (API)) to the select inference engine to swap the second set of AI models on the select inference engine in place of the first set of AI models. The request for operation 414 can comprise a swap request, and the request can specify the second set of AI models (that is being loaded by the swap request), the first set of AI models (that is being replaced by the swap request), or both.

For operation 416, the hardware processor (e.g., implementing the artificial intelligence platform 130) determines a number of inference engines of the one or more inference engines that currently have the first type of AI model loaded. For some embodiments, operation 416 is performed based on monitoring information/data generated or gathered by operation 406.

During operation 418, the hardware processor (e.g., implementing the artificial intelligence platform 130) determines whether the number of inference engines is less than a threshold number associated with the first type of AI model. According to some embodiments, the threshold number is determined (e.g., by an admin user) to ensure a dedicated number of inference engines loaded with the first type of AI model (e.g., dedicated K GPUs per model type) are maintained on a system, which can ensure a certain inference request throughput is achieved (e.g., N tokens/per second throughput) by the system. Depending on the embodiment, multiple AI model types can share a common threshold number, while one or more other AI model types can each uniquely be associated with their own threshold number.

At decision block 420, if the hardware processor determines that the number of inference engines is less than a threshold number associated with the first type of AI model, the method 400 proceeds to operation 424, otherwise the method 400 proceeds to operation 422 (where no swap is performed).

At operation 424, the hardware processor (e.g., implementing the artificial intelligence platform 130) causes the select inference engine to load the first set of AI models on the select inference engine in place of the second set of AI models. For some embodiments, operation 424 comprises sending a request (e.g., via an application programming interface (API)) to the select inference engine to swap the first set of AI models on the select inference engine in place of the second set of AI models. The request for operation 424 can comprise a swap request, and the request can specify the first set of AI models (that is being loaded by the swap request), the second set of AI models (that is being replaced by the swap request), or both.

FIG. 5 is a block diagram illustrating a system 500 that represents an example implementation of an artificial intelligence platform 130, according to some embodiments of the present disclosure. As shown, FIG. 5 comprises a request receiver 502, a dynamic model swapper 504, and a plurality of inference engines 506, which includes an inference engine 508. Depending on the embodiment, the request receiver 502 can be implemented by one or more multiple KUBERNETES replicas, the dynamic model swapper 504 can be implemented by one or more KUBERNETES replicas (e.g., multiple KUBERNETES replicas with leader election, so that a leader replica is in charge for performing swaps), and an individual inference engine can be implemented by one or more KUBERNETES replicas (e.g., single KUBERNETES replica). Additionally, an individual inference engine of the plurality of inference engines 506 can be implemented by a group of software containers, such as a KUBERNETES pod or another container orchestration pod.

During operation, the inference engine 508 comprises a loaded model 510 (e.g., active model) of a first type of AI model, and one or more available models 512 including one or more non-loaded available models 516 that are available for loading on the inference engine 508, any of which can be loaded on the inference engine 508 to replace (e.g., be swapped with) the loaded model 510 currently loaded on the inference engine 508. The inference engine 508 has one or more assigned computing resources 514, which can include computing resources that enable the loaded model 510 to operate and service inference requests. As described herein, the one or more assigned computing resources 514 can include one or more GPUs. Depending on the embodiment, the loaded model 510 can be loaded on memory of one or more GPUs. For some embodiments, each inference engine in the plurality of inference engines 506 is maintained in a running state.

According to some embodiments, the request receiver 502 receives and manages inference requests from one or more clients, the dynamic model swapper 504 facilitates swapping of AI models on individual inference engines as described herein (e.g., according to the method 400 of FIG. 4), and individual inference engines of the plurality of inference engines 506 loads AI models to service inference requests that the request receiver 502 forwards to the individual inference engines. In particular, the dynamic model swapper 504 can serve as a control plane for the system 500 and perform one or more of the following operations: aggregate inference request workloads across the plurality of inference engines 506; keep track of serving AI models and swappable AI models for each inference engine of the plurality of inference engines 506; and make a decision on reallocating or redistributing active AI models provided by the plurality of inference engines 506 by calling individual inference engine's swap model endpoints. Accordingly, the request receiver 502 can maintain a list of what AI model types are currently loaded on which inference engines, and what AI model types are available for loading on which inference engines.

The request receiver 502 can spawn a different client process for each AI model type, where a given client process can serve as a front for receiving inference requests for all inference engines of a given AI model type. The request receiver 502 can track all concurrent inflight inference requests per AI model type and can provide that information to the dynamic model swapper 504 (e.g., via an endpoint accessible to the dynamic model swapper 504). For some embodiments, every incoming inference request for a given AI model type can increment an inflight inference request count for the given AI model type by 1, and decrement the inflight inference request count for the given AI model type by 1 when an inference request completes its processing on an individual inference engine. In the event of downtime for a given AI model type (e.g., during rollouts, node upgrades, node failures, etc.), inference requests for that given AI model type can be held by the request receiver 502 until an AI model of the given AI model type is loaded (e.g., swapped in) on an individual inference engine.

The one or more assigned computing resources (e.g., 514) assigned to an individual inference engine (e.g., 508) can include a persistent data storage resource (e.g., disk or solid-state data storage) that stores non-loaded available AI models (e.g., 516) that can be loaded on the individual inference engine, thereby obviating the need for the individual inference engine to download AI models each time it needs to be loaded. Alternatively, or additionally, non-loaded available AI models (e.g., 516) that can be loaded on the individual inference engine can be stored on a primary memory included by the one or more assigned computing resources (e.g., 514) assigned to an individual inference engine (e.g., 508). For example, the primary memory can comprise RAM that is operably coupled to a CPU included by the one or more assigned computing resources (e.g., 514). In this way, the primary memory can be used as a CPU cache for storing unloaded AI models.

An individual inference engine of the plurality of inference engines 506, such as the inference engine 508, can provide one or more endpoints that facilitate AI model swapping. For example, one endpoint of the individual inference engine can be configured to return (e.g., to the dynamic model swapper 504) upon request the status of the individual inference engine, where the status can include: the AI model currently loaded on the individual inference engine (e.g., in the GPU assigned to the individual inference engine) to process an inference request; one or more AI loaded models 510 (e.g., stored on CPU cache) that can be loaded on the individual inference engine; whether the individual inference engine is in the process of swapping AI models; or a number of inference requests running on the individual inference engine. Another example endpoint of the individual inference engine can facilitate an AI model swap on the individual inference engine. According to various embodiments, when a swap request is received by an individual inference engine, the individual inference engine aborts all current running requests instead of finishing (e.g., because LLM inference can take as long as O(N) minutes and swap might be urgent to ensure minimum availability for another AI model) and marks itself as unavailable until the swap is completed. Depending on the embodiment, during the model swap process, the individual inference engine can load a designated, available AI model (e.g., specified in the swap request) from a persistent data storage resource assigned to the individual inference engine, or CPU memory (e.g., used as an AI model cache) assigned to the individual inference engine. For instance, all available AI models on the individual inference engine can be loaded into the CPU memory to facilitate fast AI model swaps. The individual inference engine can unload a first AI model (of a first type of AI model) currently loaded on the individual inference engine (currently loaded in a GPU assigned to the individual inference engine) by moving the first AI model to CPU memory (or persistent data storage), and load a second AI model (of a second type of AI model) on the individual inference engine by moving the second AI model from the CPU memory (or persistent data storage) to the GPU assigned to the individual inference engine. After the second AI model is loaded on the GPU, the second AI model can be initialized (e.g., via CUDA graph initialization command). Where there are too many AI models to load into CPU memory, the system 500 can: arrange all inference engines in a way that at any given time, for a given AI model type, the system 500 has one inference engine loaded (e.g., in GPU memory) and one inference engine unloaded (e.g., in CPU memory); or have one or more inference engines implement a least recently used (LRU) cache in CPU memory to hold the most recent AI models and load the rest of the AI models on persistent data storage. By the later option, the system 500 can treat AI model loading as a multilevel cache that involves CPU memory, persistent data storage (e.g., local disk storage), and the AI model repository.

The dynamic model swapper 504 can continuously query the request receiver 502 for how many inflight inference requests exist per AI model type, can determine the inference request load for each AI model, and can use the inference request load information to determine whether a model swap is to be performed (e.g., invoked) on one or more individual inference engines of the plurality of inference engines 506. The dynamic model swapper 504 can continuously query each of the individual inference engines of the plurality of inference engines 506 to determine what AI model they each have currently loaded, and which AI models they have available for loading. The dynamic model swapper 504 can decide to invoke an AI model swap on one or more inference engines of the plurality of inference engines 506 based on the number of pending inference request load (e.g., expressed in terms of word count or token count) per an AI model type, and based on current AI models loaded on the one or more inference engines that can be swapped by the dynamic model swapper 504. The dynamic model swapper 504 can decide to swap models on an individual inference engine based on a hard rule, a workload base rule, or both. The hard rule can indicate that there must be at least N inference engines loaded with a particular AI model type and, if at any time the number of inference engines loaded with the particular AI model type is below N, the dynamic model swapper 504 can decide to cause a model swap to occur on an individual inference engine.

When an individual inference engine (e.g., 508) receives a model swap request from the dynamic model swapper 504 while there are inflight inference requests for an AI model type currently loaded by the individual inference engine, the dynamic model swapper 504 can either: (1) cause the individual inference engine to be blocked from receiving any further inference requests, wait until all current pending inference requests on the individual inference engine to finish, then cause the AI model swap to occur on the individual inference engine; (2) cause the individual inference engine to immediately drop all pending inference requests, and then cause the AI model swap to occur on the individual inference engine; or (3) set a timeout for the AI model swap to complete based on urgency (e.g., an additional parameter can be added to the swapping endpoint, giving the individual inference engine a time to finish its inference requests before aborting all remaining inference requests and performing the AI model swap). If the number of inference engines loaded with a particular AI model type drops below a desired number for the particular AI model type, the dynamic model swapper 504 can make the individual inference engine perform an AI model swap immediately by setting its time to finish request to 0. If the case for AI model swapping is less urgent, the dynamic model swapper can let the individual inference engine finish some (if not all) pending inference requests. In the case of dropped inference requests, the request receiver 502 can comprise a retry mechanism to redirect inference requests to other inference engines that have a requested AI model type loaded. The request receiver 502 can comprise an AI model scheduler that manages and schedules inference requests (for processing) per an AI model type (instead of per inference engine), thereby enabling the request receiver 502 to hold onto incoming inference requests in a priority queue, push or forward inference requests to individual inference engines in a balanced manner (e.g., thereby keeping individual inference engines busy/saturated by not overloaded), and redirect inference requests to other inference engines that have a requested needed AI model type loaded when inference requests forwarded to an individual inference engine are dropped by the individual inference engine.

While various embodiments use word count (e.g., aggregated word count) of incoming inference requests to determine inference request workload per AI model type, for some embodiments, a tokenization is used (e.g., as a layer included by the request receiver 502 or the dynamic model swapper 504) to determine token counts (e.g., aggregated token count) of incoming inference requests to determine inference request workload per AI model type. Additionally, for some embodiments, a number of input tokens and max number of output tokens per an AI model type are used to determine the accurate time it would take for inference engines loaded with an AI model of a particular AI model type to complete pending inference request workload for the particular AI model type.

FIG. 6 illustrates a diagrammatic representation of a machine 600 in the form of a computer system within which a set of instructions can be executed for causing the machine 600 to perform any one or more of the methodologies discussed herein, according to some embodiments of the present disclosure. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein can be executed. For example, the instructions 610 may cause the machine 600 to execute any one or more operations of any one or more of the methods described herein. As another example, the instructions 610 may cause the machine 600 to implement portions of the data flows described herein. In this way, the instructions 610 transform a general, non-programmed machine into a particular machine 600 (e.g., the compute service manager 106, the execution platform 108, client device 112) that is specially configured to carry out any one of the described and illustrated functions in the manner described herein.

In alternative embodiments, the machine 600 operates as a standalone device or can be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 610, sequentially or otherwise, that specify actions to be taken by the machine 600. Further, while only a single machine 600 is illustrated, the term “machine” shall also be taken to include a collection of machines machine 600 that individually or jointly execute the instructions 610 to perform any one or more of the methodologies discussed herein.

The machine 600 includes processors 604, memory 612, and input/output (I/O) components 622 configured to communicate with each other such as via a bus 602. In an example embodiment, the processors 604 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 606 and a processor 608 that may execute the instructions 610. The term “processor” is intended to include multi-core processors 604 that may comprise two or more independent processors (sometimes referred to as “cores”) that may execute instructions 610 contemporaneously. Although FIG. 6 shows multiple processors 604, the machine 600 may include a single processor with a single core, a single processor with multiple cores (e.g., a multi-core processor), multiple processors with a single core, multiple processors with multiple cores, or any combination thereof.

The memory 612 may include a main memory 614, a static memory 616, and a storage unit 618, all accessible to the processors 604 such as via the bus 602. The main memory 614, the static memory 616, and the storage unit 618 comprising a machine storage medium 620 may store the instructions 610 embodying any one or more of the methodologies or functions described herein. The instructions 610 may also reside, completely or partially, within the main memory 614, within the static memory 616, within the storage unit 618, within at least one of the processors 604 (e.g., within the processor's cache memory), or any suitable combination thereof, during execution thereof by the machine 600.

The I/O components 622 include components to receive input, provide output, produce output, transmit information, exchange information, capture measurements, and so on. The specific I/O components 622 that are included in a particular machine 600 will depend on the type of machine. For example, portable machines such as mobile phones will likely include a touch input device or other such input mechanisms, while a headless server machine will likely not include such a touch input device. It will be appreciated that the I/O components 622 may include many other components that are not shown in FIG. 6. The I/O components 622 are grouped according to functionality merely for simplifying the following discussion and the grouping is in no way limiting. In various example embodiments, the I/O components 622 may include output components 624 and input components 626. The output components 624 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 622 may include communication components 628 operable to couple the machine 600 to a network 632 via a coupling 636 or to devices 630 via a coupling 634. For example, the communication components 628 may include a network interface component or another suitable device to interface with the network 632. In further examples, the communication components 628 may include wired communication components, wireless communication components, cellular communication components, and other communication components to provide communication via other modalities. The devices 630 can be another machine or any of a wide variety of peripheral devices (e.g., a peripheral device coupled via a universal serial bus (USB)). For example, as noted above, the machine 600 may correspond to any client device, the compute service manager 106, the execution platform 108, and the devices 630 may include any other of these systems and devices.

The various memories (e.g., 612, 614, 616, and/or memory of the processor(s) 604 and/or the storage unit 618) may store one or more sets of instructions 610 and data structures (e.g., software) embodying or utilized by any one or more of the methodologies or functions described herein. These instructions 610, when executed by the processor(s) 604, cause various operations to implement the disclosed embodiments.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 632 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 632 or a portion of the network 632 may include a wireless or cellular network, and the coupling 636 can be a Code Division Multiple Access (CDMA) connection, a Global System for Mobile communications (GSM) connection, or another type of cellular or wireless coupling. In this example, the coupling 636 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 610 can be transmitted or received over the network 632 using a transmission medium via a network interface device (e.g., a network interface component included in the communication components 628) and utilizing any one of a number of well-known transfer protocols (e.g., hypertext transfer protocol (HTTP)). Similarly, the instructions 610 can be transmitted or received using a transmission medium via the coupling 634 (e.g., a peer-to-peer coupling) to the devices 630. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 610 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: monitoring inference requests submitted to one or more inference engines, each inference engine having comprising a group of software containers that share an assigned set of computing resources, the one or more inference engines comprising a select inference engine; for each individual inference engine of the one or more inference engines: monitoring one or more available artificial intelligence models that are available for loading on the individual inference engine; and monitoring one or more loaded artificial intelligence models currently loaded on the individual inference engine to service inference requests sent to the individual inference engine; based on the monitoring of the inference requests, the monitoring of the one or more available artificial intelligence models, and the monitoring of the one or more loaded artificial intelligence models, determining whether to swap a first set of artificial intelligence models currently loaded on the select inference engine with a second set of artificial intelligence models from the one or more available artificial intelligence models, the second set of artificial intelligence models not being currently loaded on the select inference engine; and in response to determining to swap the first set of artificial intelligence models on the select inference engine with the second set of artificial intelligence models, causing the select inference engine to load the second set of artificial intelligence models on the select inference engine in place of the first set of artificial intelligence models.

In Example 2, the subject matter of Example I includes, wherein the first set of artificial intelligence models is loaded on the select inference engine by loading the first set of artificial intelligence models on one or more graphics processor units (GPUs) of the assigned set of computing resources.

In Example 3, the subject matter of Examples 1-2 includes, wherein the assigned set of computing resources comprises at least one of: one or more graphics processor units (GPUs); or one or more central processing units (CPUs).

In Example 4, the subject matter of Examples 1-3 includes, wherein the first set of artificial intelligence models is loaded on the select inference engine from a persistent data storage resource of the assigned set of computing resources.

In Example 5, the subject matter of Examples 1-4 includes, wherein the first set of artificial intelligence models is loaded on the select inference engine from a primary memory operably coupled to one or more central processing units (CPUs) of the assigned set of computing resources.

In Example 6, the subject matter of Examples 1-5 includes, wherein the inference requests are submitted to the one or more inference engines via a request receiver, and wherein the monitoring of the inference requests submitted to the one or more inference engines comprises: querying the request receiver for inference request information; and determining a request load per a different type of artificial intelligence model based on the inference request information.

In Example 7, the subject matter of Example 6 includes, wherein the request load per a different type of artificial intelligence model comprises a count of words received in inference requests per a different type of artificial intelligence model.

In Example 8, the subject matter of Examples 6-7 includes, wherein the request load per a different type of artificial intelligence model comprises a count of tokens received in inference requests per a different type of artificial intelligence model.

In Example 9, the subject matter of Examples 1-8 includes, wherein the monitoring of the one or more available artificial intelligence models on the individual inference engine comprises: querying the individual inference engine to determine the one or more available artificial intelligence models that are available for loading on the individual inference engine.

In Example 10, the subject matter of Examples 1-9 includes, wherein the monitoring of the one or more available artificial intelligence models on the individual inference engine comprises: querying the individual inference engine to determine the one or more loaded artificial intelligence models currently loaded on the individual inference engine.

In Example 11, the subject matter of Examples 1-10 includes, wherein the causing of the select inference engine to load the second set of artificial intelligence models on the select inference engine in place of the first set of artificial intelligence models comprises: unloading the first set of artificial intelligence models from the select inference engine; and after the unloading of the first set of artificial intelligence models, loading the second set of artificial intelligence models on the select inference engine.

In Example 12, the subject matter of Example 11 includes, wherein the unloading of the first set of artificial intelligence models from the select inference engine comprises: unloading the first set of artificial intelligence models from one or more graphics processor units (GPUs) of the assigned set of computing resources to a primary memory operably coupled to one or more central processing units (CPUs) of the assigned set of computing resources.

In Example 13, the subject matter of Example 12 includes, wherein the loading of the second set of artificial intelligence models on the select inference engine comprises: loading the second set of artificial intelligence models from the primary memory to the one or more graphics processor units (GPUs).

In Example 14, the subject matter of Examples 1-13 includes, wherein each artificial intelligence model in the first set of artificial intelligence models is a first type of artificial intelligence model, wherein each artificial intelligence model in the second set of artificial intelligence models is a second type of artificial intelligence model, wherein the monitoring of the inference requests submitted to the one or more inference engines comprises determining inference request loads for different types of artificial intelligence models, wherein the different types of artificial intelligence models comprises the first type of artificial intelligence model and the second type of artificial intelligence model, and wherein the determining of whether to swap the first set of artificial intelligence models currently loaded on the select inference engine with the second set of artificial intelligence models comprises: determining to swap the first set of artificial intelligence models with the second set of artificial intelligence models in response to the second type of artificial intelligence model having a higher inference request load than the first type of artificial intelligence model.

In Example 15, the subject matter of Examples 1-14 includes, wherein the operations comprise: after the causing of the select inference engine to load the second set of artificial intelligence models on the select inference engine in place of the first set of artificial intelligence models: determining a number of inference engines of the one or more inference engines that currently have a first type of artificial intelligence model loaded; determining whether the number of inference engines is less than a threshold number associated with the first type of artificial intelligence model; and in response to determining that the number of inference engines is less than the threshold number associated with the first type of artificial intelligence model, causing the select inference engine to load the first set of artificial intelligence models on the select inference engine in place of the second set of artificial intelligence models.

In Example 16, the subject matter of Examples 1-15 includes, wherein at least one artificial intelligence model of the one or more artificial intelligence models comprises a large language model.

In Example 17, the subject matter of Examples 1-16 includes, wherein the individual inference engine comprises a group of software containers that share the assigned computing resources of the individual inference engine, and wherein the group of software containers is a container orchestration pod.

Example 18 is a method to implement any of Examples 1-17.

Example 19 is a machine-storage medium, the machine-storage medium including instructions that when executed by a machine, cause the machine to perform operations to implement any of Examples 1-17.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
monitoring inference requests submitted to one or more inference engines, each inference engine having an assigned set of computing resources, the one or more inference engines comprising a select inference engine;
for each individual inference engine of the one or more inference engines:
monitoring one or more available artificial intelligence models that are available for loading on the individual inference engine; and
monitoring one or more loaded artificial intelligence models currently loaded on the individual inference engine to service inference requests sent to the individual inference engine;
based on the monitoring of the inference requests, the monitoring of the one or more available artificial intelligence models, and the monitoring of the one or more loaded artificial intelligence models, determining whether to swap a first set of artificial intelligence models currently loaded on the select inference engine with a second set of artificial intelligence models from the one or more available artificial intelligence models, the second set of artificial intelligence models not being currently loaded on the select inference engine; and
in response to determining to swap the first set of artificial intelligence models on the select inference engine with the second set of artificial intelligence models, causing the select inference engine to load the second set of artificial intelligence models on the select inference engine in place of the first set of artificial intelligence models.

2. The system of claim 1, wherein the first set of artificial intelligence models is loaded on the select inference engine by loading the first set of artificial intelligence models on one or more graphics processor units (GPUs) of the assigned set of computing resources.

3. The system of claim 1, wherein the assigned set of computing resources comprises at least one of:
one or more graphics processor units (GPUs); or
one or more central processing units (CPUs).

4. The system of claim 1, wherein the first set of artificial intelligence models is loaded on the select inference engine from a persistent data storage resource of the assigned set of computing resources.

5. The system of claim 1, wherein the first set of artificial intelligence models is loaded on the select inference engine from a primary memory operably coupled to one or more central processing units (CPUs) of the assigned set of computing resources.

6. The system of claim 1, wherein the inference requests are submitted to the one or more inference engines via a request receiver, and wherein the monitoring of the inference requests submitted to the one or more inference engines comprises:
querying the request receiver for inference request information; and
determining a request load per a different type of artificial intelligence model based on the inference request information.

7. The system of claim 6, wherein the request load per a different type of artificial intelligence model comprises a count of words received in inference requests per a different type of artificial intelligence model.

8. The system of claim 6, wherein the request load per a different type of artificial intelligence model comprises a count of tokens received in inference requests per a different type of artificial intelligence model.

9. The system of claim 1, wherein the monitoring of the one or more available artificial intelligence models on the individual inference engine comprises:
querying the individual inference engine to determine the one or more available artificial intelligence models that are available for loading on the individual inference engine.

10. The system of claim 1, wherein the monitoring of the one or more available artificial intelligence models on the individual inference engine comprises:
querying the individual inference engine to determine the one or more loaded artificial intelligence models currently loaded on the individual inference engine.

11. The system of claim 1, wherein the causing of the select inference engine to load the second set of artificial intelligence models on the select inference engine in place of the first set of artificial intelligence models comprises:
unloading the first set of artificial intelligence models from the select inference engine; and
after the unloading of the first set of artificial intelligence models, loading the second set of artificial intelligence models on the select inference engine.

12. The system of claim 11, wherein the unloading of the first set of artificial intelligence models from the select inference engine comprises:
unloading the first set of artificial intelligence models from one or more graphics processor units (GPUs) of the assigned set of computing resources to a primary memory operably coupled to one or more central processing units (CPUs) of the assigned set of computing resources.

13. The system of claim 12, wherein the loading of the second set of artificial intelligence models on the select inference engine comprises:
loading the second set of artificial intelligence models from the primary memory to the one or more graphics processor units (GPUs).

14. The system of claim 1, wherein each artificial intelligence model in the first set of artificial intelligence models is a first type of artificial intelligence model, wherein each artificial intelligence model in the second set of artificial intelligence models is a second type of artificial intelligence model, wherein the monitoring of the inference requests submitted to the one or more inference engines comprises determining inference request loads for different types of artificial intelligence models, wherein the different types of artificial intelligence models comprises the first type of artificial intelligence model and the second type of artificial intelligence model, and wherein the determining of whether to swap the first set of artificial intelligence models currently loaded on the select inference engine with the second set of artificial intelligence models comprises:
determining to swap the first set of artificial intelligence models with the second set of artificial intelligence models in response to the second type of artificial intelligence model having a higher inference request load than the first type of artificial intelligence model.

15. The system of claim 1, wherein the operations comprise:
after the causing of the select inference engine to load the second set of artificial intelligence models on the select inference engine in place of the first set of artificial intelligence models:
determining a number of inference engines of the one or more inference engines that currently have a first type of artificial intelligence model loaded;
determining whether the number of inference engines is less than a threshold number associated with the first type of artificial intelligence model; and
in response to determining that the number of inference engines is less than the threshold number associated with the first type of artificial intelligence model, causing the select inference engine to load the first set of artificial intelligence models on the select inference engine in place of the second set of artificial intelligence models.

16. The system of claim 1, wherein at least one artificial intelligence model of the one or more artificial intelligence models comprises a large language model.

17. The system of claim 1, wherein the individual inference engine comprises a group of software containers that share the assigned computing resources of the individual inference engine, and wherein the group of software containers is a container orchestration pod.

18. A method comprising:
monitoring, by a hardware processor, inference requests submitted to one or more inference engines, each inference engine having an assigned set of computing resources, the one or more inference engines comprising a select inference engine;
for each individual inference engine of the one or more inference engines:
monitoring one or more available artificial intelligence models that are available for loading on the individual inference engine; and
monitoring one or more loaded artificial intelligence models currently loaded on the individual inference engine to service inference requests sent to the individual inference engine;
based on the monitoring of the inference requests, the monitoring of the one or more available artificial intelligence models, and the monitoring of the one or more loaded artificial intelligence models, determining, by the hardware processor, whether to swap a first set of artificial intelligence models currently loaded on the select inference engine with a second set of artificial intelligence models from the one or more available artificial intelligence models, the second set of artificial intelligence models not being currently loaded on the select inference engine; and
in response to determining to swap the first set of artificial intelligence models on the select inference engine with the second set of artificial intelligence models, causing, by the hardware processor, the select inference engine to load the second set of artificial intelligence models on the select inference engine in place of the first set of artificial intelligence models.

19. The method of claim 18, wherein the first set of artificial intelligence models is loaded on the select inference engine by loading the first set of artificial intelligence models on one or more graphics processor units (GPUs) of the assigned set of computing resources.

20. The method of claim 18, wherein the assigned set of computing resources comprises at least one of:
one or more graphics processor units (GPUs); or
one or more central processing units (CPUs).

21. The method of claim 18, wherein the first set of artificial intelligence models is loaded on the select inference engine from a persistent data storage resource of the assigned set of computing resources.

22. The method of claim 18, wherein the first set of artificial intelligence models is loaded on the select inference engine from a primary memory operably coupled to one or more central processing units (CPUs) of the assigned set of computing resources.

23. The method of claim 18, wherein the inference requests are submitted to the one or more inference engines via a request receiver, and wherein the monitoring of the inference requests submitted to the one or more inference engines comprises:
querying the request receiver for inference request information; and
determining a request load per a different type of artificial intelligence model based on the inference request information.

24. The method of claim 23, wherein the request load per a different type of artificial intelligence model comprises a count of words received in inference requests per a different type of artificial intelligence model.

25. The method of claim 23, wherein the request load per a different type of artificial intelligence model comprises a count of tokens received in inference requests per a different type of artificial intelligence model.

26. The method of claim 18, wherein the monitoring of the one or more available artificial intelligence models on the individual inference engine comprises:
querying the individual inference engine to determine the one or more available artificial intelligence models that are available for loading on the individual inference engine.

27. The method of claim 18, wherein the monitoring of the one or more available artificial intelligence models on the individual inference engine comprises:
querying the individual inference engine to determine the one or more loaded artificial intelligence models currently loaded on the individual inference engine.

28. The method of claim 18, wherein the causing of the select inference engine to load the second set of artificial intelligence models on the select inference engine in place of the first set of artificial intelligence models comprises:
unloading the first set of artificial intelligence models from the select inference engine; and
after the unloading of the first set of artificial intelligence models, loading the second set of artificial intelligence models on the select inference engine.

29. The method of claim 28, wherein the unloading of the first set of artificial intelligence models from the select inference engine comprises:
unloading the first set of artificial intelligence models from one or more graphics processor units (GPUs) of the assigned set of computing resources to a primary memory operably coupled to one or more central processing units (CPUs) of the assigned set of computing resources.

30. A machine-storage medium, the machine-storage medium including instructions that when executed by a machine, cause the machine to perform operations comprising:
monitoring inference requests submitted to one or more inference engines, each inference engine having an assigned set of computing resources, the one or more inference engines comprising a select inference engine;
for each individual inference engine of the one or more inference engines:
monitoring one or more available artificial intelligence models that are available for loading on the individual inference engine; and
monitoring one or more loaded artificial intelligence models currently loaded on the individual inference engine to service inference requests sent to the individual inference engine;
based on the monitoring of the inference requests, the monitoring of the one or more available artificial intelligence models, and the monitoring of the one or more loaded artificial intelligence models, determining whether to swap a first set of artificial intelligence models currently loaded on the select inference engine with a second set of artificial intelligence models from the one or more available artificial intelligence models, the second set of artificial intelligence models not being currently loaded on the select inference engine; and
in response to determining to swap the first set of artificial intelligence models on the select inference engine with the second set of artificial intelligence models, causing the select inference engine to load the second set of artificial intelligence models on the select inference engine in place of the first set of artificial intelligence models.
